(19) United States
(12) Patent Application Publication
(10) Pub. No.: US 2007/0291373 A1
(43) Pub. Date: Dec. 20, 2007

(54) COUPLING DEVICES AND METHODS FOR LASER EMITTERS

(75) Inventors: Yongdan Hu, Tucson, AZ (US); Jim Harrison, Oro Valley, AZ (US)

Correspondence Address: GRANT ANDERSON LLP;C/O PORTFOLIOIP, P.O. BOX 52050, MINNEAPOLIS, MN, 55402, US

(73) Assignee: Newport Corporation, Irvine, CA (US)

(21) Appl. No.: 11/759,885

(22) Filed: Jun. 7, 2007

Related U.S. Application Data
(60) Provisional application No. 60/881,642, filed on Jan. 22, 2007.
(60) Provisional application No. 60/814,565, filed on Jun. 15, 2006.

(51) Int. Cl. G02B 27/30

(52) U.S. Cl. 359/641

(57) ABSTRACT

Embodiments include methods and devices for coupling light energy from laser emitters having a high spectral brightness and purity that may be used for a variety of purposes including the pumping of various laser gain materials.

### RELATED APPLICATIONS

This application claims priority under 35 U.S.C. section 119(e) from U.S. Provisional Patent application Ser. No. 60/881,642 titled “Coupling Devices and Methods for Laser Emitters”, filed Jan. 22, 2007, by Hu, Y. et al. and U.S. Provisional Patent application Ser. No. 60/814,565 titled “Diode Laser System and Method of Manufacture”, filed Jun. 15, 2006, by Srinivasan, R. et al., both of which are also incorporated by reference herein in their entirety.

### BACKGROUND

Applications requiring light energy and specifically laser energy may benefit form the use of solid state light sources such as laser diodes which are commonly available, reliable to operate and relatively cost effective as a laser energy source. Such devices may include a single laser emitter or a plurality of laser emitters in a emitter bar that emit laser light simultaneously in a common direction. Typically the emitters of such solid state emitter bars are spaced from each other to allow sufficient cooling without the need for elaborate and expensive cooling systems.

Laser diode bars are often used for communication technology devices, medical applications and other applications where it is desirable to couple the output of all the emitters of a single solid state emitter bar into a single optical fiber or other optical conduit. The spatial and spectral distribution of the emitter or emitters of a bar can make coupling the output of emitters challenging, particularly when coupling to a small diameter optical fiber. Also, the spectral distribution of a particular emitter or group of emitters may be too broad for particular applications.

A micro-lens or micro-lens array may be used to reduce the divergence angle among the beam or beams emanating from an emitter bar. However, a solid state emitter bar which incorporates several, transversely separated emitters requires that an objective lens or lenses having a large numerical aperture be used if the beam is to be concentrated into a usefully small spot. Large numerical aperture objective lenses tend to be expensive. In addition, the alignment of multiple small micro-lenses or micro-lens arrays can be a difficult and time consuming process. Other devices such as volume index gratings (VIGs) may be used to narrow or otherwise control the spectral band of a laser emitter light energy output, however, such devices typically have fairly rigid acceptance criteria regarding the input angle and wavelength of light energy.

As such, what has been needed are efficient methods and devices for coupling light energy from one or more laser emitters while maintaining a narrow spectral bandwidth, high degree of spectral brightness, purity and coupling efficiency.

### SUMMARY

Some embodiments of an optical apparatus include a laser emitter having a fast axis, a slow axis and an emission axis that is substantially perpendicular to the fast and slow axes aligned with an optical path of the apparatus. A fast axis collimator element is disposed adjacent the laser emitter, disposed in the optical path and configured to collimate light energy output of the laser emitter in a fast axis direction. A slow axis collimator element is disposed in the optical path and configured to collimate light energy output of the emitter in slow axis direction. A wavelength control element integrally formed with the slow axis collimator element is disposed in the optical path and configured to provide optical feedback to the laser emitter so as to control a spectral band of the light energy output of the laser emitter.

Some embodiments of an optical apparatus include an emitter bar having a plurality of laser emitters each having a fast axis, a slow axis and an emission axis that is substantially perpendicular to the fast and slow axes. The laser emitters are disposed in a substantially linear configuration along a slow axis direction of the laser emitters. A fast axis collimator element is disposed adjacent the emitter bar, disposed in an optical path of the apparatus and configured to collimate light energy output of the emitters of the emitter bar in a fast axis direction. A slow axis collimator element is disposed in the optical path and configured to collimate light energy output of the emitters of the emitter bar in slow axis direction. A wavelength control element is formed integrally with the slow axis collimator and configured to provide optical feedback to the emitters of the emitter bar so as to narrow a spectral band of the light energy output of the emitters.

Some embodiments of an integrated optical element for coupling laser emitter light energy include a wavelength control element and a slow axis collimator element integrally formed with the wavelength control element. For some embodiments, a fast axis collimator element is also integrally formed with the wavelength control element and the slow axis collimator element with the wavelength control element disposed between the slow axis collimator element and the fast axis collimator element. For some embodiments, the optical element is formed from a single piece of optical material with the slow axis collimator element formed into the material and a VIG written into the material adjacent the slow axis collimator element.

Some embodiments of a method of coupling light energy into an optical conduit include emitting light energy from at least one laser emitter, collimating the emitted light energy in a fast axis direction with a fast axis collimator element, collimating the emitted light energy in a slow axis direction with a slow axis collimator element and controlling the wavelength of the emitted light energy with optical feedback generated by a wavelength control element integrally formed with the slow axis collimator element. The method also includes directing the light energy into an optical conduit, which may include focusing the light energy into an optical fiber for some embodiments.

These features of embodiments will become more apparent from the following detailed description when taken in conjunction with the accompanying exemplary drawings.

### BRIEF DESCRIPTION OF THE DRAWINGS

FIG. 1 is a perspective view of a laser emitter bar having a single laser emitter.

FIG. 2 is a side view of an optical apparatus for coupling the output of a laser emitter bar into an optical fiber.

FIG. 3 is a top view of the optical apparatus of FIG. 2.

FIG. 4 is a side view of an optical apparatus for coupling the output of a laser emitter bar into an optical fiber.

FIG. 5 is a top view of the optical apparatus of FIG. 4.

FIG. 6 is a perspective view of a laser emitter bar having 5 laser emitters disposed in a substantially linear configuration along a slow axis direction.

FIG. 7 is a side view of an optical apparatus for coupling the output of a laser emitter bar into an optical fiber.

FIG. 8 is a top view of the optical apparatus of FIG. 7.

### DETAILED DESCRIPTION

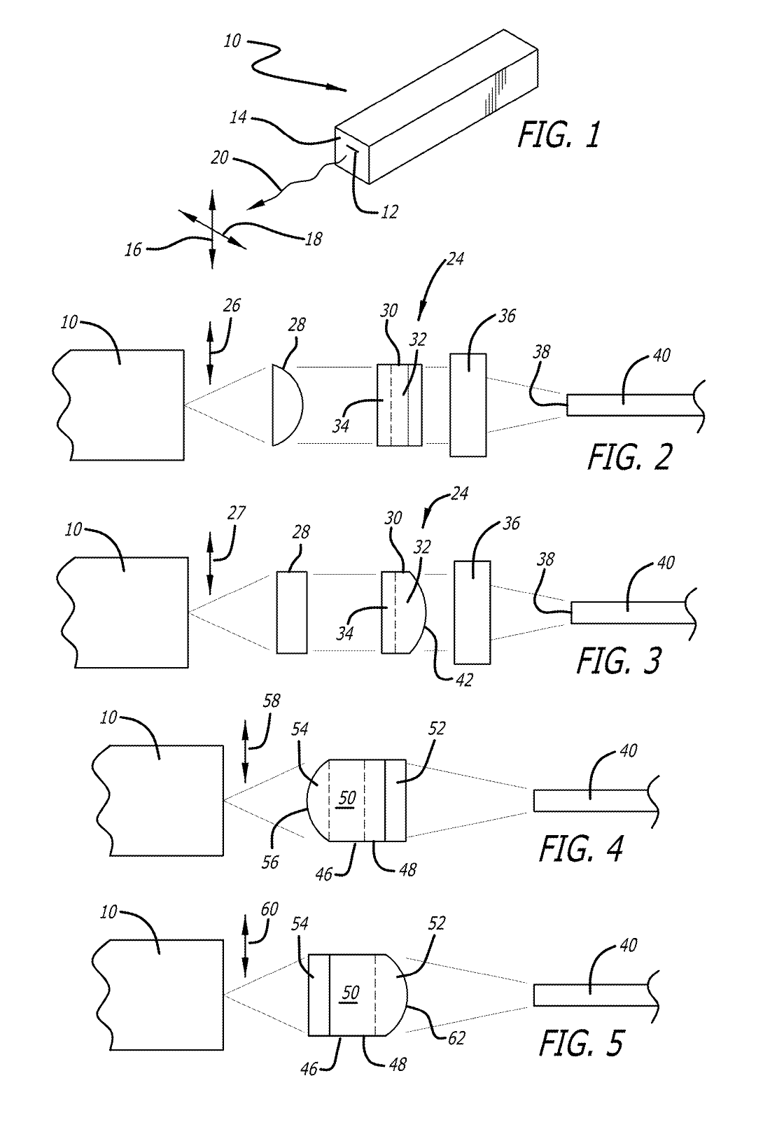

FIG. 1 shows a laser emitter bar 10 having a single laser emitter 12 disposed on an output surface 14. A fast axis direction of light energy emitted from the laser emitter 12 is indicated by arrow 16 which is perpendicular to a slow axis direction of light energy emitted from the laser emitter 12, indicated by arrow 18. The laser emitter 12 is positioned or otherwise configured so as to emit light energy in an output beam that propagates along an emission axis 20 which may be perpendicular to both the slow axis direction 18 and fast axis direction 16. The emission axis 20 of the laser emitter 12 may also be substantially perpendicular to the output surface 14 of the laser emitter bar 10.

Generally, the emitting aperture of some laser diode embodiments of the laser emitter 12 may be rectangular in shape with the long dimension along the slow axis direction 18 of the laser emitter 12 having a size of typically tens or hundreds of microns, while the short dimension along the fast axis direction 16 is typically one to several microns in size. Radiation such as light energy emerging from a laser emitter 12 diverges with the divergence angle being greater along the short or fast axis emitter direction 16. Divergence angles are lower in the direction of the long or slow axis emitter direction. Some embodiments of the laser emitter 12 may have a physical width in the slow axis direction 18 of about 50 microns to about 300 microns, a height in the fast axis direction 16 of about 1 micron to about 3 microns, and a cavity length along the emission axis direction of about 0.5 mm to about 5 mm. Such laser emitter embodiments 12 may have a divergence of light energy output of about 2 degrees to about 12 degrees in the slow axis direction 18 and a divergence of light energy output of about 30 degrees to about 75 degrees in the fast axis direction 16. Some laser emitter embodiments 12 may include laser diodes such as edge emitting laser diodes, vertical cavity surface emitting lasers (VCSELs) and the like. Materials for some embodiments of the laser emitter of the laser emitter bar 10 may include semiconductor materials such as GaAs, InP or any other suitable laser gain medium.

Some embodiments of the laser emitter 12 may emit light energy having a wavelength of about 700 nm to about 1500 nm, more specifically, about 800 nm to about 1000 nm. In addition, some embodiments of laser emitter 12 may emit light having a centroid or peak wavelength of about 300 nm to about 2000 nm, more specifically, of about 600 nm to about 1000 nm, including wavelengths across the near infrared spectrum. Some embodiments of useful laser emitters 12 may emit light at a peak wavelength of about 350 nm to about 550 nm, 600 nm to about 1350 nm or about 1450 nm to about 2000 nm. Such laser emitters 12 may be operated in either a pulsed mode or continuous wave mode. Frequently, the output spectral band of individual laser emitters 12 which are not wavelength controlled (for example wavelength controlled by providing wavelength-dependent feedback from a VIG or the like) may be about 0.5 nm to about 2.0 nm or more. Due to the variation in peak emission wavelength in addition to the spectral band for each individual laser emitter 12, the overall bandwidth of a laser emitter bar embodiment that includes multiple laser emitters, discussed in more detail below, may be about 2 nm to about 5 nm, for some embodiments.

FIGS. 2 and 3 illustrate an optical apparatus 24 that may be used for coupling light energy from a laser emitter 12 into an optical conduit with the use of an integrated optical element. The optical apparatus 24 includes the laser emitter bar 10 with a laser emitter 12 having a fast axis indicated by arrow 26, a slow axis indicated by arrow 27 and an emission axis that is substantially perpendicular to the fast and slow axes and substantially aligned with an optical path of the apparatus 24. A fast axis collimator element 28 is disposed adjacent the laser emitter 12, disposed in the optical path of the apparatus 24 and configured to collimate light energy output of the laser emitter 12 in a fast axis direction 26. An integrated optical element 30 includes a slow axis collimator element 32 disposed in the optical path of the apparatus 24 and configured to collimate light energy output of the emitter 12 in slow axis direction 27. The integrated optical element 30 also includes a wavelength control element 34 disposed adjacent the slow axis collimator element 32. The wavelength control element 34 is disposed in the optical path of the apparatus 24 between the fast axis collimator element 28 and the slow axis collimator element 32 and is configured to provide optical feedback to the laser emitter 12 so as to control a spectral band of the light energy output of the laser emitter 12. Focusing optics 36 are aligned with an output axis of the integrated optical element 30 and are configured to focus light energy into an input surface 38 of an optical fiber 40 having an input axis aligned with an output axis of the focusing optics 36.

The fast axis collimator element 28 may be a cylindrical lens or a portion thereof having a focal length that is configured to substantially collimate light energy from the laser emitter 12 in a fast axis direction 26. The collimation of light energy in the fast axis direction 26 for some embodiments may be sufficient such that at least about 70 percent of the emitted light energy from the laser emitter 12 incident on the wavelength control element 34 is within an acceptance angle of the wavelength control element 34. For such a configuration, the wavelength control element 34 may reflect about 5 percent to about 35 percent of the incident light energy back towards the laser emitter 12 in the form of optical feedback. Some embodiments of the cylindrical lens of the fast axis collimator element 28 may have a width in the fast axis direction 26 of about 0.5 mm to about 1 mm, a thickness of about 0.3 mm to about 2 mm and a focal length of about 0.15 mm to about 1 mm. Suitable materials for the fast axis collimator element 28 may include quartz, silica glass as well as other optical materials.

The integrated optical element embodiment 30 shown is formed from a single piece of optical material, however, similar embodiments may be made from separate elements which are thereafter bonded or otherwise secured together to form a unitary structure. The integrated optical element 30 as a whole or portions thereof may be made from a variety of suitable optical materials such as quartz, silica glass and the like. However, for embodiments of the integrated optical element 30 that are made from a single optical material, it may be useful for the optical material to be a photo-sensitive material so that a wavelength control element 34 in the form of a VIG or the like may be written or otherwise created directly into the optical material adjacent the slow axis collimator element 32. Such optical materials may include photo-refractive crystal materials such as LiNbO₃ and BGO. The optical material may also include glasses, polymers and dichromated gelatins.

The slow axis collimator element 32 is a cylindrical lens formed into the optical material of the integrated optical element 30 that substantially collimates the light energy output of the laser emitter 12 in the slow axis direction 27 and has a convex outer surface 42. Some embodiments of the cylindrical lens of the slow axis collimator element 32 of the integrated optical element 30 may have a width in the slow axis direction 27 of about 1 mm to about 12 mm, a thickness of about 1 mm to about 5 mm and a focal length of about 2 mm to about 10 mm.

The wavelength control element 34 shown is a VIG which is written into the optical material of the integrated optical element 30 adjacent the slow axis collimator element 32. Creation of periodic perturbations in a zone of the optical material of the integrated optical element 30 adjacent the slow axis collimator element 32 may be used to generate the wavelength control element 34 in the optical material of the integrated optical element 30. The wavelength control element 34 may be used to narrow a spectral band of the light energy of the laser emitter 12. Such VIG embodiments may also be known as volume Bragg gratings (VBGs), volume holographic gratings (VHGs) or any other suitable device. The wavelength control element 34 may be generated to have a variety of useful configurations including a chirped configuration, a graded configuration or the like. Chirped or graded VIG configurations may be used to provide predetermined patterns or spectral profiles for the optical feedback reflected from the wavelength control element 34 back into the laser emitter 12. The VIG or wavelength control element 34 shown may have a width along the slow axis direction 27 of about 1 mm to about 12 mm and a thickness of about 0.3 mm to about 3 mm.

In use, light energy may be coupled into an optical conduit, such as fiber optic 40, by emitting light energy from the laser emitter 12 and collimating the emitted light energy in a fast axis direction 26 with the fast axis collimator element 28. The fast axis collimated light energy then propagates from the fast axis collimator element 28 to the wavelength control element 34 of the integrated optical element 30. Light energy having a suitable angle of incidence with respect to the wavelength control element 34 for acceptance into the wavelength control element 34 may then enter the wavelength control element 34. For some embodiments, at least about 70 percent of the emitted light energy incident on the wavelength control element 34 is collimated in a fast axis direction 26 sufficiently to be within an acceptance angle of the wavelength control element 34.

Some embodiments of the wavelength control element 34 may then control or otherwise modify the wavelength or spectral band of the light energy by providing optical feedback to the laser emitter 12. As discussed above, for some embodiments, the light energy of the optical feedback from the wavelength control element 34 may include a narrowed spectral band with respect to the light energy incident on the wavelength control element 34 from the laser emitter 12. Such a configuration may provide at least about 5 percent reflection of the light energy incident on the wavelength control element 34 back towards the laser emitter 12 in the form of optical feedback with the reflected optical feedback having been controlled or narrowed in the spectral band. The light energy which has not been reflected passes through the wavelength control element 34 and is then collimated in the slow axis direction 27 with the slow axis collimator element 32. The light energy may then be focused by the focusing optics 36 and directed into the fiber optic 40.

FIGS. 4 and 5 illustrate an embodiment of an optical apparatus 46 that may be used for coupling light energy from the laser emitter 12 of the laser emitter bar 10 into the optical fiber 40. The optical apparatus 46 includes an integrated optical element 48 having a wavelength control element 50, a slow axis collimator element 52 and a fast axis collimator element 54. The wavelength control element 50 is disposed between the fast axis collimator element 54 and slow axis collimator element 52 with all three elements 50, 52 and 54 being integrally formed together into the single unitary integrated optical element 48. The fast axis collimator element 54, slow axis collimator element 52 and wavelength control element 50 of the integrated optical element 48 may have the same or similar features, dimensions and materials as the fast axis collimator element 28, slow axis collimator element 32 and wavelength control element 34, respectively, of the optical apparatus 24 discussed above. However, the fast axis collimator element 54 and slow axis collimator element 52 of the embodiment shown in FIGS. 4 and 5 may also have sufficient power to serve as focusing optics as well as collimating optical elements for some embodiments.

The integrated optical element 48 shown having all three elements 50, 52 and 54 is formed from a single piece of optical material, however, similar embodiments may be made from separate elements which are thereafter bonded or otherwise secured together to form a unitary structure. The integrated optical element 48 as a whole or portions thereof may be made from a variety of suitable optical materials such as quartz, silica glass and the like. However, for embodiments of the integrated optical element 48 that are made from a single optical material, it may be useful for the optical material to be a photo-sensitive material, such as those discussed above, so that a wavelength control element 50 in the form of a VIG or the like may be written or otherwise created directly into the optical material between the slow axis collimator element 52 and the fast axis collimator element 54.

The fast axis collimator element 54 may be a cylindrical lens or a portion thereof having an outer convex surface 56 and a focal length that is configured to substantially collimate and focus light energy from the laser emitter 12 in a fast axis direction 58. The collimation and focusing of light energy in the fast axis direction 58 for some embodiments may be sufficient such that at least about 70 percent of the emitted light energy from the laser emitter 12 incident on the wavelength control element 50 is within an acceptance angle of the wavelength control element 50. Some embodiments of the cylindrical lens of the fast axis collimator element 54 may have a width along the fast axis direction 58 of about 1 mm to about 5 mm, a thickness of about 1 mm to about 5 mm and a focal length of about 0.5 mm to about 10 mm. Suitable materials for the fast axis collimator element 54 may include quartz, silica glass and the like.

The slow axis collimator element 52 is a cylindrical lens formed into the optical material of the integrated optical element 48 that substantially collimates and focuses the light energy output of the laser emitter 12 in the slow axis direction 60 and has a convex outer surface 62. Some embodiments of the cylindrical lens of the slow axis collimator element 52 of the integrated optical element 48 may have a width along the slow axis direction 60 of about 1 mm to about 12 mm, a thickness of about 1 mm to about 5 mm and a focal length of about 2 mm to about 10 mm.

The wavelength control element 50 in the form of a VIG may be written or otherwise formed into the material between the slow axis collimator element 52 and fast axis collimator element 54. As discussed above, the creation of periodic perturbations in a zone of the optical material of the integrated optical element 48 adjacent the slow axis collimator element 52 may be used to generate the wavelength control element 50 in the optical material of the integrated optical element 48. The wavelength control element 50 may be used to narrow a spectral band of the light energy of the laser emitter 12 and may also have a chirped configuration, a graded configuration or the like. The VIG or wavelength control element 50 shown may have a width along the slow axis direction 60 of about 1 mm to about 12 mm and a thickness of about 0.5 mm to about 6 mm.

In use, light energy may be coupled into an optical conduit, such as fiber optic 40, by emitting light energy from the laser emitter 12. The emitted light energy then enters the fast axis collimator element 54 of the integrated optical element 48 where the emitted light energy is collimated and focused in the fast axis direction 58. The fast axis collimated and focused light energy then propagates from the fast axis collimator element 54 to the wavelength control element 50 of the integrated optical element 48.

Light energy having a suitable angle of incidence with respect to the wavelength control element 50 may then enter the wavelength control element 50 or otherwise be transformed by the wavelength control element 50. For some embodiments, at least about 70 percent of the emitted light energy incident on the wavelength control element 50 is collimated and focused in a fast axis direction 58 sufficiently to be within an acceptance angle of the wavelength control element 50. Some embodiments of the wavelength control element 50 may then control or otherwise modify the wavelength or spectral band of a portion of the light energy and provide optical feedback to the laser emitter 12 in the form of reflected light energy. For some embodiments, at least about 5 percent of the light energy incident on the wavelength control element 50 is reflected back towards the laser emitter 12 to provide optical feedback to the laser emitter 12.

As discussed above, for some embodiments, the light energy of the optical feedback from the wavelength control element 50 may include a narrowed spectral band with respect to the light energy incident on the wavelength control element from the laser emitter 12. Light energy that has not been reflected by the wavelength control element 50 may then pass through the wavelength control element 50 and be collimated and focused in the slow axis direction 60 with the slow axis collimator element 52. The focused light energy may then be directed into the fiber optic 40 or any other suitable optical conduit or receptacle.

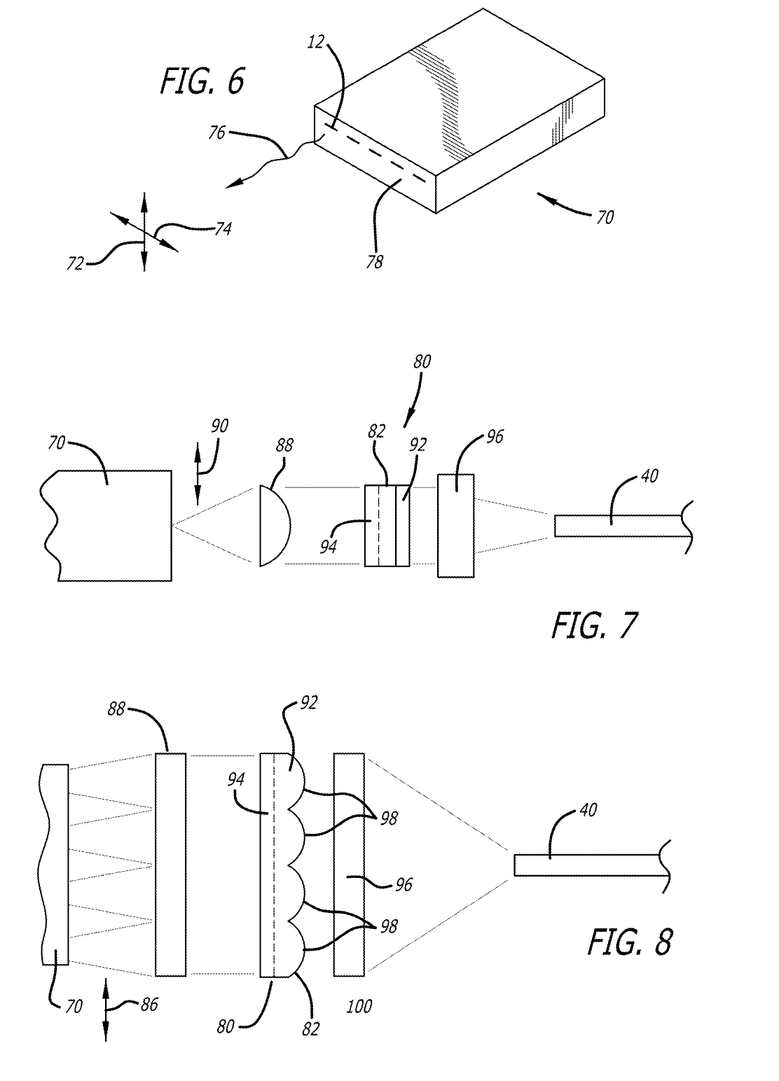

FIG. 6 illustrates a laser emitter bar 70 having 5 laser emitters 12 which individually may have the same or similar characteristics to the characteristics of the emitter 12 of laser emitter bar 10 discussed above. A fast axis direction of light energy emitted from the emitters 12 is indicated by arrow 72 and is perpendicular to a slow axis direction of light energy emitted from the emitters which is indicated by arrow 74. The emitters 12 are positioned or otherwise configured so as to emit light energy in output beams that propagate along an emission axis 76 which may be perpendicular to both the slow axis direction 74 and fast axis direction 72. The emission axes 76 of the emitters 12 may be substantially perpendicular to an output surface 78 of the laser emitter bar 70 and parallel to each other. The emitters 12 are disposed on the output surface 78 of the emitter bar 70 in a substantially linear arrangement along the slow axis direction 74 of light energy emitted from the emitters 12.

Laser emitter bar embodiments 70 having multiple laser emitters 12 may have any suitable number of laser emitters, such as about 2 laser emitters 12 to about 100 laser emitters 12, more specifically, about 10 laser emitters 12 to about 66 laser emitters 12. Some laser emitter bar embodiments 70 may include an even number of laser emitters 12 such as about 8, 10, 20, 38 or 48 emitters 12. For some embodiments, each laser emitter bar 70 having about 6 emitters may have an output power of about 5 W to about 50 W, more specifically, about 10 W to about 20 W. Due to the variation in peak emission wavelength in addition to the spectral band for each individual laser emitter 12, the overall bandwidth of a laser emitter bar embodiment 70 that includes multiple laser emitters 12 may be about 2 nm to about 5 nm.

FIGS. 7 and 8 illustrate an optical apparatus 80 having an integrated optical element 82 that may be used for coupling light energy to an optical conduit 40. The optical apparatus 80 includes the emitter bar 70 having a plurality of laser emitters 12 each having a fast axis 72, a slow axis 74 and an emission axis 76 that is substantially perpendicular to the fast and slow axes. The laser emitters 12 are disposed in a substantially linear configuration along the slow axis direction of the laser emitters 12 indicated by arrow 86. A fast axis collimator element 88 is disposed adjacent the emitter bar 70, disposed in an optical path of the apparatus 80 and configured to collimate light energy output of the emitters 12 of the emitter bar 70 in a fast axis direction indicated by arrow 90. The integrated optical element 82 includes a slow axis collimator element 92 and a wavelength control element 94 formed together from a single piece of optical material. The slow axis collimator element 92 is disposed in the optical path and configured to collimate light energy output of the emitters 12 of the emitter bar 70 in the slow axis direction 86. The wavelength control element 94 is configured to provide optical feedback to the emitters 12 of the emitter bar 70 so as to narrow a spectral band of the light energy output of the emitters 12. Focusing optics 96 are aligned with an output axis of the slow axis collimator element 92 in order to focus the light energy into the optical fiber 40 having an input axis aligned with an output axis of the focusing optics 96. For the embodiment shown, the slow axis collimator element 92 includes an array of slow axis collimator lenses 98 and the fast axis collimator element 88 is a singlet cylindrical lens. However, for some embodiments, the fast axis collimator element 88 may also include an array of fast axis collimator lenses (not shown).

The fast axis collimator element 88 may be a cylindrical lens or a portion thereof having a focal length that is configured to substantially collimate light energy from the laser emitters 12 in the fast axis direction 90. The collimation of light energy in the fast axis direction 90 for some embodiments may be sufficient such that at least about 70 percent of the emitted light energy from the laser emitters 12 incident on the wavelength control element 94 is within an acceptance angle of the wavelength control element 94. For such a configuration, the wavelength control element 94 may reflect about 5 percent of the incident light energy back towards the laser emitters 12 in the form of optical feedback. Some embodiments of the cylindrical lens of the fast axis collimator element 88 may have a width along the fast axis direction 90 of about 0.5 mm to about 1 mm, a thickness of about 0.3 mm to about 2 mm and a focal length of about 0.15 mm to about 1 mm. Suitable materials for the fast axis collimator element 88 may include quartz, silica glass as well as other suitable optical materials.

The integrated optical element embodiment 82 shown is formed from a single piece of optical material, however, similar embodiments may be made from separate elements which are thereafter bonded or otherwise secured together to form a unitary structure. The integrated optical element 82 as a whole or portions thereof may be made from a variety of suitable optical materials such as quartz, silica glass and the like. Integrated optical element embodiments 82 that are made from a single optical material may be made from a photo-sensitive material, such as those discussed above, so that the wavelength control element 94 in the form of a VIG or the like may be written or otherwise created directly into the optical material adjacent the slow axis collimator element 92.

The slow axis collimator element 92 is an array of cylindrical lenses 98 formed into the optical material of the integrated optical element 82. Each cylindrical lens 98 substantially collimates the light energy output of a respective laser emitter 12 in the slow axis direction 86. Each cylindrical lens 98 of the array has a convex outer surface 100 and may have a width along the slow axis direction 86 of about 5 mm to about 12 mm, a thickness of about 1 mm to about 5 mm and a focal length of about 2 mm to about 10 mm.

The wavelength control element 94 shown is a VIG which is written into the optical material of the integrated optical element 82 adjacent the cylindrical lens array of the slow axis collimator element 92. The VIG may be created as discussed above with periodic perturbations generated in a zone of the optical material of the integrated optical element 82 adjacent the slow axis collimator element 92 and may include a chirped configuration, a graded configuration or the like. The VIG or wavelength control element 94 shown may have a width along the slow axis direction 86 of about 5 mm to about 12 mm and a thickness of about 0.3 mm to about 3 mm.

In use, light energy may be coupled into an optical conduit, such as fiber optic 40, by emitting light energy from the laser emitters 12 of the laser emitter bar 70 and collimating the emitted light energy in the fast axis direction 90 with the fast axis collimator element 88. The fast axis collimated light energy then propagates from the fast axis collimator element 88 to the wavelength control element 94 of the integrated optical element 82. Light energy having a suitable angle of incidence with respect to the wavelength control element 94 for acceptance into the wavelength control element 94 may then enter the wavelength control element 94. For some embodiments, at least about 70 percent of the emitted light energy incident on the wavelength control element 94 is collimated in a fast axis direction sufficiently to be within an acceptance angle of the wavelength control element 94.

Some embodiments of the wavelength control element 94 may then control or otherwise modify the wavelength or spectral band of the light energy by providing optical feedback to the laser emitters 12. As discussed above, for some embodiments, the light energy of the optical feedback from the wavelength control element 94 may include a narrowed spectral band with respect to the spectral band of the light energy incident on the wavelength control element 94 from the laser emitters 12. Such a configuration may provide at least about 5 percent reflection of the light energy incident on the wavelength control element 94 back towards the laser emitters 12 in the form of optical feedback with the reflected optical feedback having been controlled or narrowed in the spectral band. The light energy of each laser emitter 12 which has not been reflected by the wavelength control element 94 then passes through the wavelength control element 94. This light energy is then collimated in the slow axis direction 86 by a respective cylindrical lens 98 of the cylindrical lens array of the slow axis collimator element 92. The light energy may then be focused by the focusing optics 96 and directed into the fiber optic 40 or any other suitable optical conduit or receptacle.

Although the embodiment of the optical apparatus of FIGS. 7 and 8 show a single laser emitter bar 70 having a plurality of laser emitters 12, other embodiments of a similar optical apparatus 80 may include multiple laser emitter bars 70 having single or multiple emitters 12. For example, two or more laser emitter bars 70 may be disposed in a stacked configuration with emitters 12 thereof substantially aligned in a fast axis direction 90. Additional optical elements, including fast axis collimator elements 88 and corresponding integrated optical elements 82, corresponding to and optically aligned with each laser emitter bar 70 may then be used in order to facilitate coupling of light energy emitted from such a stacked array of laser emitter bars 70 into a single optical conduit or multiple respective optical conduits.

With regard to the above detailed description, like reference numerals used therein refer to like elements that may have the same or similar dimensions, materials and configurations. While particular forms of embodiments have been illustrated and described, it will be apparent that various modifications can be made without departing from the spirit and scope of the embodiments of the invention. Accordingly, it is not intended that the invention be limited by the forgoing detailed description.

What is claimed is:

1. An optical apparatus, comprising:
a laser emitter having a fast axis, a slow axis and an emission axis that is substantially perpendicular to the fast and slow axes aligned with an optical path of the apparatus;
a fast axis collimator element disposed adjacent the laser emitter, disposed in the optical path and configured to collimate light energy output of the laser emitter in a fast axis direction;
a slow axis collimator element disposed in the optical path and configured to collimate light energy output of the laser emitter in slow axis direction; and
a wavelength control element integrally formed with the slow axis collimator element, disposed in the optical path and configured to provide optical feedback to the laser emitter so as to control a spectral band of the light energy output of the laser emitter.

2. The optical apparatus of claim 1 further comprising focusing optics aligned with an output axis of the slow axis collimator element.

3. The optical apparatus of claim 2 further comprising an optical fiber having an input axis aligned with an output axis of the focusing optics.

4. The optical apparatus of claim 1 wherein the wavelength control element comprises a VIG.

5. The optical apparatus of claim 4 wherein the VIG is a chirped VIG.

6. The optical apparatus of claim 4 wherein the slow axis collimator element and wavelength control element are formed from a single piece of optical material and the slow axis collimator element is formed into the material and the VIG is written into the material adjacent the slow axis collimator element.

7. The optical apparatus of claim 6 wherein the optical material comprises a photo-refractive crystal material.

8. The optical apparatus of claim 7 wherein the photo-refractive crystal material is selected from LiNbO₃ and BGO.

9. The optical apparatus of claim 6 wherein the optical material comprises a material selected from photosensitive glasses, polymers and dichromated gelatins.

10. The optical apparatus of claim 1 wherein the wavelength control element is configured to narrow a spectral band of the light energy emitted from the laser emitter.

11. The optical apparatus of claim 1 wherein the fast axis collimator element is integrally formed into a single optical element with the slow axis collimator element and the wavelength control element.

12. The optical apparatus of claim 1 wherein the fast axis collimator element is configured to collimate the emitted light energy in a fast axis direction sufficiently such that at least about 70 percent of the emitted light energy incident on the wavelength control element is within an acceptance angle of the wavelength control element.

13. An optical apparatus, comprising:
an emitter bar having a plurality of laser emitters each having a fast axis, a slow axis and an emission axis that is substantially perpendicular to the fast and slow axes disposed in a substantially linear configuration along a slow axis direction of the laser emitters;
a fast axis collimator element disposed adjacent the emitter bar, disposed in an optical path of the apparatus and configured to collimate light energy output of the laser emitters of the emitter bar in a fast axis direction;
a slow axis collimator element disposed in the optical path and configured to collimate light energy output of the laser emitters of the emitter bar in slow axis direction; and
a wavelength control element formed integrally with the slow axis collimator and configured to provide optical feedback to the laser emitters of the emitter bar so as to narrow a spectral band of the light energy output of the emitters.

14. The optical apparatus of claim 13 further comprising focusing optics aligned with an output axis of the slow axis collimator element.

15. The optical apparatus of claim 14 further comprising an optical fiber having an input axis aligned with an output axis of the focusing optics.

16. The optical apparatus of claim 13 wherein the wavelength control element comprises a VIG.

17. The optical apparatus of claim 16 wherein the VIG is a chirped VIG.

18. The optical apparatus of claim 16 wherein the slow axis collimator element and wavelength control element are formed from a single piece of optical material and the slow axis collimator element is formed into the material and the VIG is written into the material adjacent the slow axis collimator element.

19. The optical apparatus of claim 18 wherein the optical material comprises a photo-refractive crystal material.

20. The optical apparatus of claim 19 wherein the photo-refractive crystal material is selected from LiNbO₃ and BGO.

21. The optical apparatus of claim 18 wherein the optical material comprises a material selected from photosensitive glasses, polymers and dichromated gelatins.

22. The optical apparatus of claim 13 wherein the wavelength control element is configured to narrow a spectral band of the light energy emitted from the laser emitter.

23. The optical apparatus of claim 13 wherein the fast axis collimator element is integrally formed with the slow axis collimator element and the wavelength control element.

24. The optical apparatus of claim 13 wherein the fast axis collimator element is configured to collimate the emitted light energy in a fast axis direction sufficiently such that at least about 70 percent of light energy incident on the wavelength control element is within an acceptance angle of the wavelength control element.

25. The optical apparatus of claim 13 wherein the slow axis collimator element comprises an array of slow axis collimator lenses.

26. The optical apparatus of claim 13 wherein the fast axis collimator element comprises an array of fast axis collimator lenses.

27. An integrated optical element for coupling laser emitter light energy, comprising
a wavelength control element; and
a slow axis collimator element integrally formed with the wavelength control element.

28. The optical element of claim 27 further comprising a fast axis collimator element integrally formed with the wavelength control element and the slow axis collimator element.

29. The optical element of claim 28 wherein the wavelength control element is disposed between the slow axis collimator element and the fast axis collimator element.

30. The optical element of claim 27 wherein the slow axis collimator element comprises a slow axis collimator element array.

31. The optical element of claim 27 wherein the wavelength control element comprises a VIG.

32. The optical element of claim 31 wherein the optical element is formed from a single piece of optical material and the slow axis collimator element is formed into the material and the VIG is written into the material adjacent the slow axis collimator element.

33. The optical element of claim 32 wherein the optical material comprises a photo-refractive crystal material.

34. The optical element of claim 33 wherein the photo-refractive crystal material is selected from LiNbO₃ and BGO.

35. The optical element of claim 32 wherein the optical material comprises a material selected from photosensitive glasses, polymers and dichromated gelatins.

36. A method of coupling light energy into an optical conduit, comprising
emitting light energy from at least one laser emitter;
collimating the emitted light energy in a fast axis direction with a fast axis collimator element;
collimating the emitted light energy in a slow axis direction with a slow axis collimator element;
controlling the wavelength of the emitted light energy with optical feedback generated by a wavelength control element integrally formed with the slow axis collimator element; and
directing the light energy into an optical conduit.

37. The method of claim 36 wherein the emitted light energy is collimated in a fast axis direction by a fast axis collimator element that is integrally formed with the slow axis collimator element and the wavelength control element.

38. The method of claim 36 further comprising focusing the collimated and wavelength controlled emitted light energy into an optical conduit.

39. The method of claim 38 further comprising focusing the collimated and wavelength controlled emitted light energy into an optical fiber.

40. The method of claim 36 wherein at least about 70 percent of the emitted light energy incident on the wavelength control element is collimated in a fast axis direction sufficiently to be within an acceptance angle of the wavelength control element.

41. The method of claim 36 wherein directing the light energy into an optical conduit comprises focusing the light energy into an optical fiber.
